(19) United States
(12) Patent Application Publication
(10) Pub. No.: US 2024/0296195 A1
(43) Pub. Date: Sep. 5, 2024

(54) SYSTEM, METHOD AND COMPUTER-READABLE MEDIUM FOR RECOMMENDATION

(71) Applicant: 17LIVE Japan Inc., Tokyo (JP)

(72) Inventors: Jayneel PAWAR, Tokyo (JP); Manasvi GHELANI, Tokyo (JP); Sree LAKSHMI, Tokyo (JP); Abinash SEN, Tokyo (JP); Anmol MOHAN, Tokyo (JP)

(21) Appl. No.: 18/456,181

(22) Filed: Aug. 25, 2023

(30) Foreign Application Priority Data
Mar. 2, 2023 (JP) 2023-031650

(51) Int. Cl. G06F 16/9536; G06F 16/9535

(52) U.S. Cl. CPC G06F 16/9536; G06F 16/9535

(57) ABSTRACT

The present disclosure relates to a system, a method and a computer-readable medium for recommendation. The method includes obtaining viewer interaction data of a plurality of content types; determining distance values between different content types according to the viewer interaction data; determining a first viewer and a second viewer to have viewed a same content type; determining a distance value between a first content type viewed by the first viewer and a second content type viewed by the second viewer according to the distance values; and determining whether or not to recommend a stream corresponding to the first content type to the second viewer according to the distance value.

This application is based on and claims the benefit of priority from Japanese Patent Application Serial No. 2023-031650 (filed on Mar. 2, 2023), the contents of which are hereby incorporated by reference in its entirety.

### TECHNICAL FIELD

The present disclosure relates to recommendations in the streaming field.

### BACKGROUND

Real time interaction on the Internet, such as live streaming service, has become popular in our daily life. There are various platforms or providers providing the service of live streaming, and the competition is fierce. It is important for a platform to provide to its users their desired contents.

Japanese patent application publication JP2019-164617A discloses a system for recommending live videos to users.

### SUMMARY

A method according to one embodiment of the present disclosure is a method for recommendation being executed by one or a plurality of computers, and includes: obtaining viewer interaction data of a plurality of content types; determining distance values between different content types according to the viewer interaction data; determining a first viewer and a second viewer to have viewed a same content type; determining a distance value between a first content type viewed by the first viewer and a second content type viewed by the second viewer according to the distance values; and determining whether or not to recommend a stream corresponding to the first content type to the second viewer according to the distance value.

A system according to one embodiment of the present disclosure is a system for recommendation that includes one or a plurality of processors, and the one or plurality of computer processors execute a machine-readable instruction to perform: obtaining viewer interaction data of a plurality of content types; determining distance values between different content types according to the viewer interaction data; determining a first viewer and a second viewer to have viewed a same content type; determining a distance value between a first content type viewed by the first viewer and a second content type viewed by the second viewer according to the distance values; and determining whether or not to recommend a stream corresponding to the first content type to the second viewer according to the distance value.

A computer-readable medium according to one embodiment of the present disclosure is a non-transitory computer-readable medium including a program for recommendation, and the program causes one or a plurality of computers to execute: obtaining viewer interaction data of a plurality of content types; determining distance values between different content types according to the viewer interaction data; determining a first viewer and a second viewer to have viewed a same content type; determining a distance value between a first content type viewed by the first viewer and a second content type viewed by the second viewer according to the distance values; and determining whether or not to recommend a stream corresponding to the first content type to the second viewer according to the distance value.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 shows an example of the interaction DB 350 according to some embodiments of the present disclosure.

FIG. 8 shows an example of data stored in the distance DB 352 according to some embodiments of the present disclosure.

FIG. 9 shows an example of data stored in the distance DB 352 according to some embodiments of the present disclosure.

FIG. 10 shows an exemplary flow chart illustrating a method according to some embodiments of the present disclosure.

FIG. 11 shows an exemplary flow according to some embodiments of the present disclosure.

FIG. 12 shows an example of viewer interaction data generation according to some embodiments of the present disclosure.

FIG. 13 shows an example of recording similar viewers according to some embodiments of the present disclosure.

FIG. 14 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

Some conventional recommendation methods utilize similarity between viewers to recommend their desired contents. The viewers are required to enter their preferences such that similar viewers can be determined. Then the conventional method may recommend viewer A's newly watched content to viewer B, who is a similar viewer with viewer A. However, very often the recommended content would be similar to or the same as what viewer B already watched. Therefore there is a lack of content diversification in the recommending system. Conventional recommendation methods cannot help a viewer to explore new content types he or she may like.

The present disclosure provides systems or methods to recommend contents in a more diversified manner.

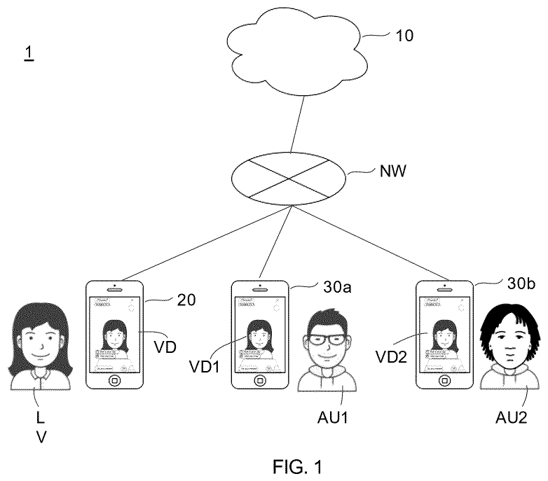

FIG. 1 shows a schematic configuration of a live streaming system 1 according to some embodiments of the present disclosure. The live streaming system 1 provides a live streaming service for the streaming streamer (could be referred to as liver, anchor, or distributor) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

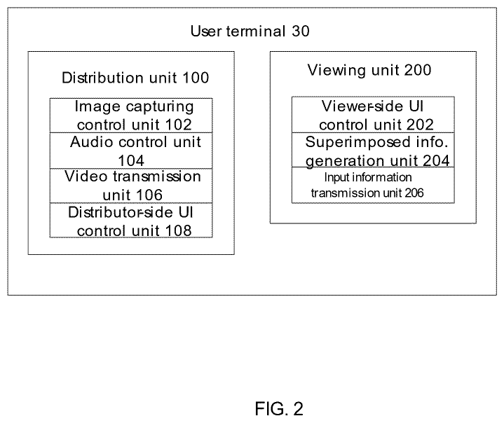

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

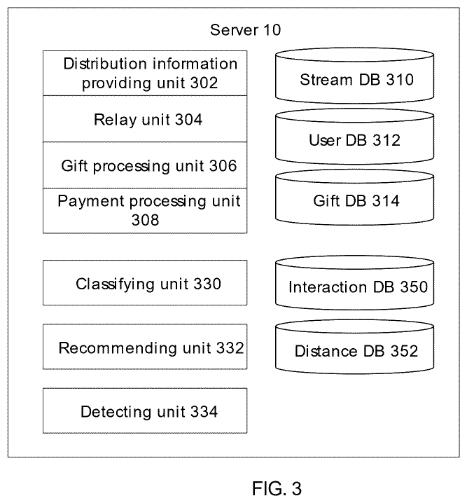

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a classifying unit 330, a recommending unit 332, a detecting unit 334, an interaction DB 350, and a distance DB 352.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

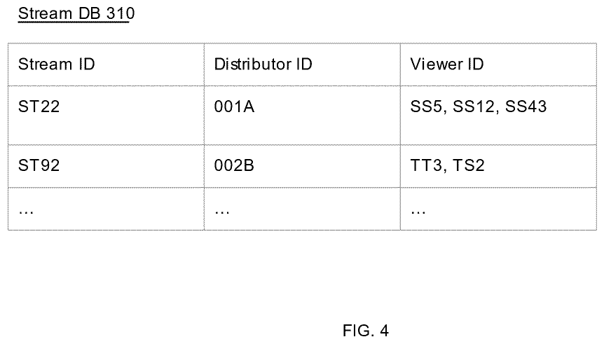

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

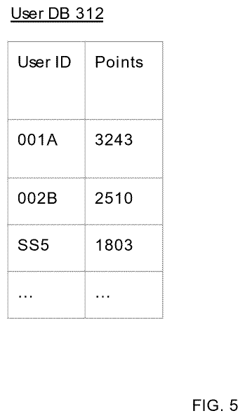

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user bolds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

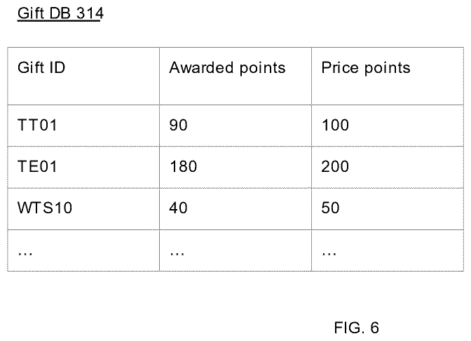

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 12 may be set as the price points, or points obtained by adding predetermined fee points to the awarded points may be set as the price points.

The classifying unit 330 is configured to classify content types. The classifying unit 330 is configured to determine or calculate distance values between different content types according to viewer interaction data. The classifying unit 330 may obtain the viewer interaction data of a plurality of content types, and determine the distances among or between them accordingly.

In some embodiments, the classifying unit 330 determines a distance value between two content types to be less (that is, shorter distance) when the viewer interaction data indicates that more viewers interacted with or liked both the two content types. In some embodiments, the classifying unit 330 determines a distance value between two content types to be greater (that is, longer distance) when the viewer interaction data indicates that less viewers interacted with or liked both the two content types. In some embodiments, the determined distance values are stored in the distance DB 352.

The recommending unit 332 is configured to recommend contents or streams to viewers. In some embodiments, the recommending unit 332 determines viewer A and viewer B to have viewed (or interacted with) the same (or similar) content type(s) (or same/similar stream(s)). Viewer A and viewer B may therefore be considered as similar viewers accordingly. The recommending unit 332 determines or obtains a content type A viewed (or interacted with) by viewer A and a content type B viewed (or interacted with) by viewer B. The recommending unit 332 determines a distance value between content type A and content type B according to the distance values determined (or calculated) by the classifying unit 330. The recommending unit 332 then determines whether or not to recommend content type A (or a stream corresponding to content type A, or a stream having content type A) to viewer B according to the distance value.

In some embodiments, the recommending unit 332 determines to recommend content type A to viewer B only when the recommending unit 332 determines the distance value to be equal to or greater than a distance threshold. In some embodiments, the recommending unit 332 determines NOT to recommend content type A to viewer B when the recommending unit 332 determines the distance value to be less than a distance threshold.

In some embodiments, the recommending unit 332 obtains all content types viewed (or interacted with) by viewer B (within a predetermined time period, for example). The recommending unit 332 determines a distance value between content type A and each content type viewed (or interacted with) by viewer B according to the distance values determined (or calculated) by the classifying unit 330. The recommending unit 332 then determines whether or not to recommend content type A (or a stream corresponding to content type A, or a stream having content type A) to viewer B according to the distance values.

In some embodiments, the recommending unit 332 determines to recommend content type A to viewer B only when the recommending unit 332 determines that the distance value between content type A and each content type viewed (or interacted with) by viewer B to be equal to or greater than a distance threshold. In some embodiments, the recommending unit 332 determines NOT to recommend content type A to viewer B when the recommending unit 332 determines that at least one distance value between content type A and a content type viewed (or interacted with) by viewer B to be less than a distance threshold.

The above threshold(s) could be set according to actual practice or experience, or according to various distance value calculation methods. In some embodiments, threshold values can be adjusted periodically. Correlations between the threshold values and click rates of the recommended contents can be calculated and monitored. The correlation trends can be fed back to the threshold value setting such that higher click rates can be achieved. A machine learning model could be utilized in the process to learn to adjust the threshold values.

The detecting unit 334 is configured to detect or obtain user behavior during playing of a stream or a content. The detecting unit 334 is configured to detect viewers' actions or interactions during viewing contents. The detecting unit 334 could be configured to detect viewers' actions or interactions with respect to different content types respectively. The detecting unit 334 is configured to generate viewer interaction data according to the detected results.

For example, in some embodiments, the detecting unit 334 detects a timing of an interaction action from a viewer towards a stream (or a content). The detecting unit 334 detects a content type of the stream at the timing. The detecting unit 334 therefore generates the viewer interaction data including the data (or record) indicating that the viewer performed an interaction action towards (or interacted with) the content type. The interaction action corresponds to the content type. In some embodiments, the viewer interaction data is stored in the interaction DB 350. For example, the detected viewer behavior (or actions, or interactions) and the detected content type are stored in the interaction DB 350.

In some embodiments, the viewer interactions may include view durations, comment numbers, sharing actions, following actions, gifting numbers, gifting amount, and/or number of watched streams, from viewers. In some embodiments, the viewer interaction data may include view durations, comment numbers, sharing actions, following actions, gifting numbers, gifting amount, and/or number of watched streams, from viewers, with respect to content types.

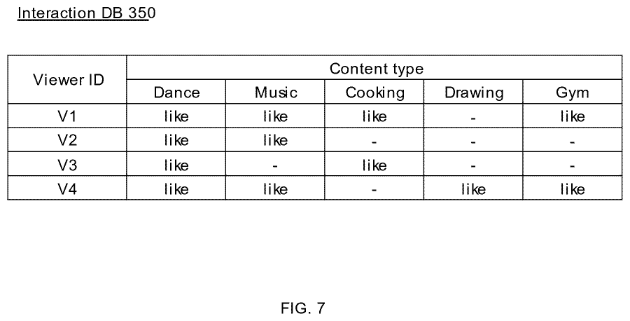

FIG. 7 shows an example of the interaction DB 350 according to some embodiments of the present disclosure. The interaction DB 350 stores interaction actions performed by viewers towards content types. The data stored in the interaction DB 350 could be referred to as viewer interaction data. The data could be stored by the detecting unit 334.

The “like” mark indicates that the corresponding viewer has performed an interaction action toward or during the corresponding content type. For example, viewer V1 liked or interacted with the content types Dance, Music, Cooking and Gym. The criteria of recording a “like” mark could be various and could be adjusted according to actual practice. For example, a “like” mark could be recorded if the viewer views the content type for a predetermined time duration. For example, a “like” mark could be recorded if the viewer comments toward or during the content type. For example, a “like” mark could be recorded if the viewer follows a streamer when the streamer performs the content type. For example, a “like” mark could be recorded if the viewer shares the stream when the streamer performs the content type. For example, a “like” mark could be recorded if the viewer gives gifts toward or during the content type. For example, a “like” mark could be recorded if the viewer watches a predetermined number of streams containing the content type.

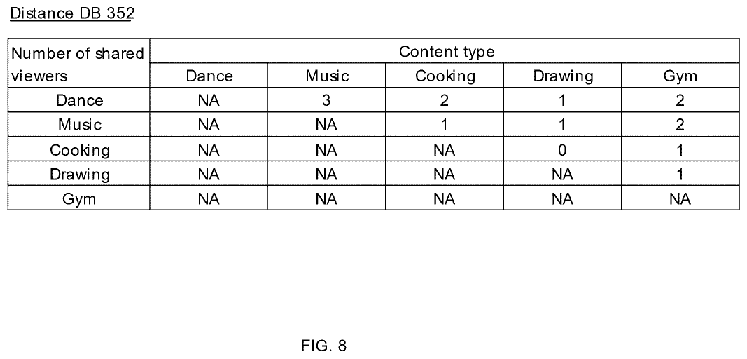

FIG. 8 shows an example of data stored in the distance DB 352 according to some embodiments of the present disclosure. Number of shared viewers (or common viewers) are recorded for each content type pair. Shared viewers are viewers who interact with (or view, in some embodiments) BOTH the two content types. For example, 3 viewers interacted with both the content types Music and Dance (viewers V1, V2 and V4 in FIG. 7). For example, only 1 viewer interacted with both the content types Drawing and Dance (viewer V4 in FIG. 7). For example, no viewer interacted with both the content types Drawing and Cooking (as shown in FIG. 7). The data could be stored by the classifying unit 330.

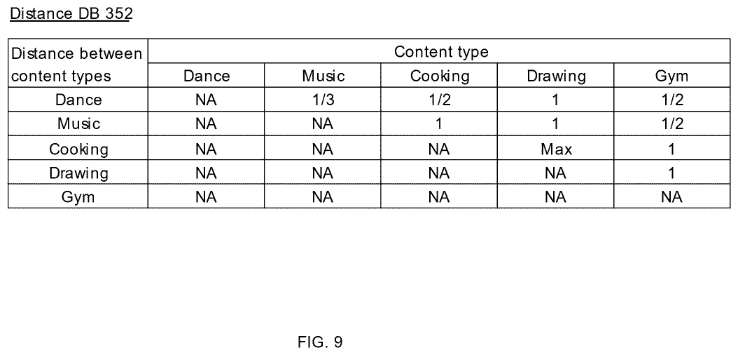

FIG. 9 shows an example of data stored in the distance DB 352 according to some embodiments of the present disclosure. In this embodiment, the distance value between two content types is the reciprocal of the number of their shared viewers. That is, the distance value in FIG. 9 is the reciprocal of the corresponding number of shared viewers in FIG. 8. For example, for the Music and Dance pair, the number of shared viewers is 3, and the distance value would be ⅓. For example, for the Drawing and Cooking pair, the number of shared viewers is 0, and the distance value is indicated as Max (or could be a predetermined large value, in some embodiments).

In some embodiments, a distance value between two content types is determined to be less when more viewers interact with both the two content types. In some embodiments, a distance value between two content types is determined to be greater when fewer viewers interact with both the two content types. In some embodiments, the distance value could be inversely proportional to the number of shared viewers.

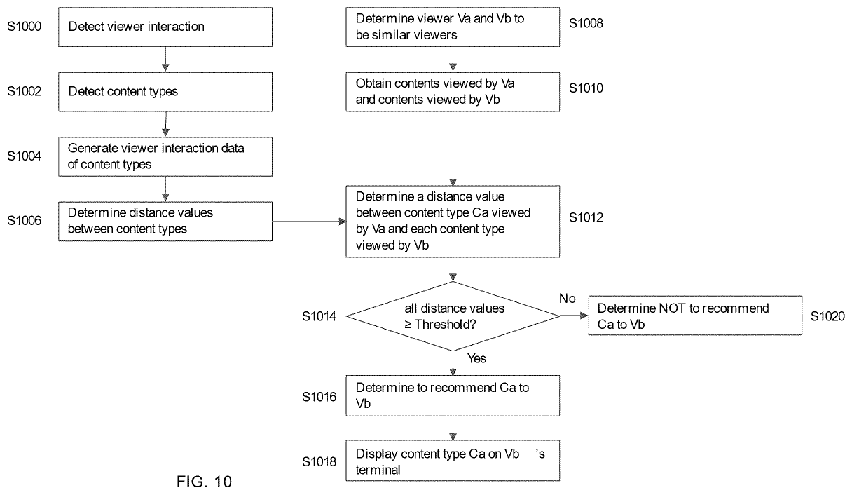

FIG. 10 shows an exemplary flow chart illustrating a method according to some embodiments of the present disclosure.

At step S1000, viewer interactions (or viewer interaction actions) are detected by the detecting unit 334.

At step S1002, content types corresponding to the viewer interactions are detected by the detecting unit 334. Content types at the timings of the viewer interactions are detected by the detecting unit 334.

At step S1004, viewer interaction data of content types are generated by the detecting unit 334 and stored into the interaction DB 350.

At step S1006, distance values between content types are determined according to the viewer interaction data, by the classifying unit 330. The distance values are stored in the distance DB 352.

At step S1008, viewer Va and viewer Vb are determined to be similar viewers, by the recommending unit 332, for example. Viewers Va and Vb may have viewed or interacted with similar or same contents (or streams).

At step S1010, contents (or new contents) viewed by viewer Va and contents (or new contents) viewed by viewer Vb are obtained, by the recommending unit, for example.

At step S1012, a distance value between a content type Ca viewed by viewer Va and each content type viewed by viewer Vb (within a predetermined time period, for example) is determined according to the distance values determined (or calculated) in step S1006. The process could be performed by the recommending unit 332.

At step S1014, the recommending unit 332, for example, determines if all distance values determined in step S1012 are equal to or greater than a distance threshold. If yes, the flow goes to step S1016. If not, the flow goes to step S1020.

At step S1016, the recommending unit 332 determines to recommend the content type Ca to viewer Vb. For example, the recommending unit 332 may trigger the server 10 (or the distribution information providing unit 302) to transmit information of content type Ca to the user terminal of viewer Vb. The information may include stream(s) containing content type Ca, which could be the stream watched by viewer Va, for example.

At step S1018, information of content type Ca is displayed on the user terminal of viewer Vb. Viewer Vb may select accordingly to view the stream corresponding to content type Ca.

At step S1020, the recommending unit 332 determines not to recommend the content type Ca to viewer Vb. For example, the recommending unit 332 may prevent the server 10 (or the distribution information providing unit 302) from transmitting information of content type Ca to the user terminal of viewer Vb.

In some embodiments, a recommendation method involving detection or utilization of similar viewers could be referred to as a User-User-Filtering (UUF) recommendation method or a Collaborative filtering (CF) recommendation method.

Some or all of the above processes could be executed in a real time manner. For example, viewer interactions can be detected in a real time manner. The corresponding content types could be detected in a real time manner. The viewer interaction data could be updated in a real time manner. The distance values between content types could be calculated and updated in a real time manner. Once a content type Ca is determined to be able to be recommended to viewer Vb, the system may detect (in a real time manner) a content that is in line with content type C in a stream (that is being played in real time) and recommend the stream to viewer Vb in a real time manner.

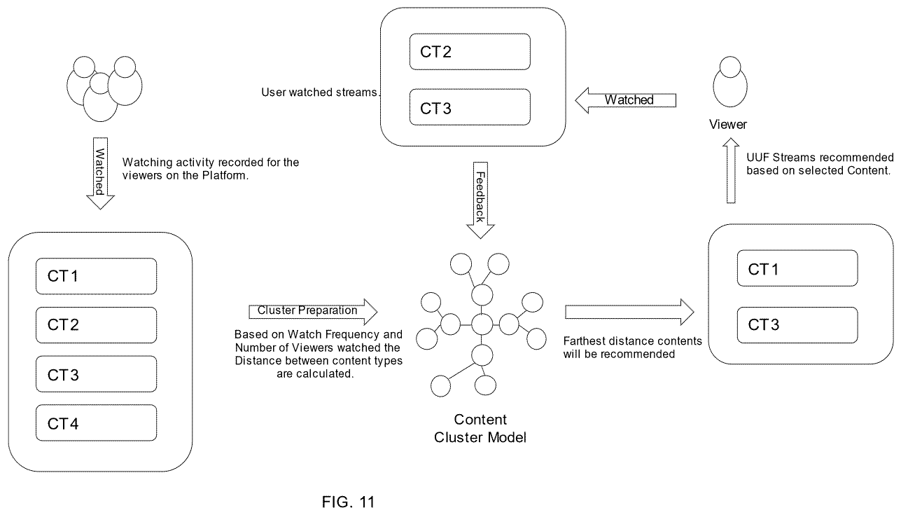

FIG. 11 shows an exemplary flow according to some embodiments of the present disclosure. Watching activities of viewers are recorded on the streaming platform. During cluster preparation, the content cluster model (or category-distance model) classifies the contents. Specifically, based on parameters such as watch frequency and number of viewers who watched various contents, the distance between content types are calculated. The process could be similar to the classifying processes described above. The content cluster model could be the classifying unit 330 in some embodiments. Subsequently, the farthest-distance contents are recommended to viewers, wherein a UUF recommendation method is utilized as described above. The newly watched data will then be fed back to the content cluster model to update the content cluster model.

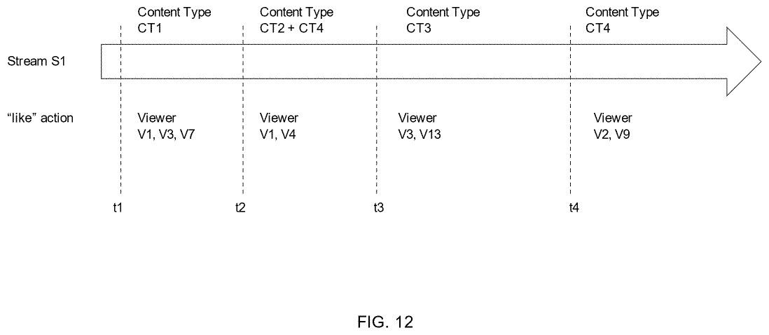

FIG. 12 shows an example of viewer interaction data generation according to some embodiments of the present disclosure.

During playing of S1, at timing t1 (or during time duration t1˜t2), interaction actions corresponding to a “like” mark are detected from viewers V1, V3 and V7. The content in the corresponding timing (or time duration) is detected to include content type CT1. At timing t2 (or during time duration t2˜t3), interaction actions corresponding to a “like” mark are detected from viewers V1 and V4. The content in the corresponding timing (or time duration) is detected to include content types CT2 and CT4. Similar detections are executed for various streams. All the interaction data could be stored in the interaction DB 350.

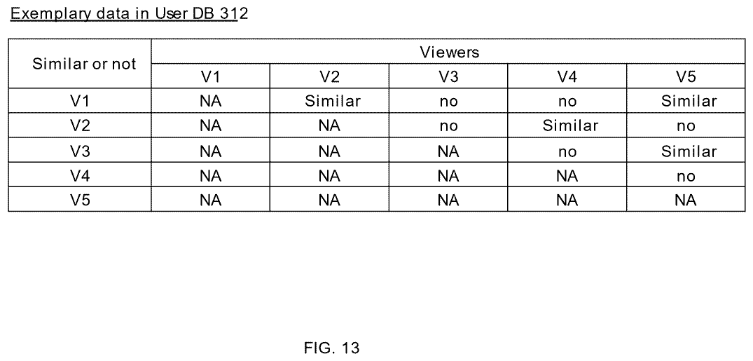

FIG. 13 shows an example of recording similar viewers according to some embodiments of the present disclosure. The exemplary data could be stored as part of the user DB 312 by the recommending unit 332 or by the detecting unit 334, according to viewing history of the viewers. For example, viewers V1 and V2 may have viewed or interacted with similar or same content(s) such that they are marked as similar viewers.

The present disclosure can avoid feeding a viewer contents similar to what he or she already viewed. The present disclosure can help viewers explore the content types (or new contents) that are different from what they have viewed and are likely to be loved by them. The present disclosure can improve variability (or diversification) in content recommendation and can increase user engagement.

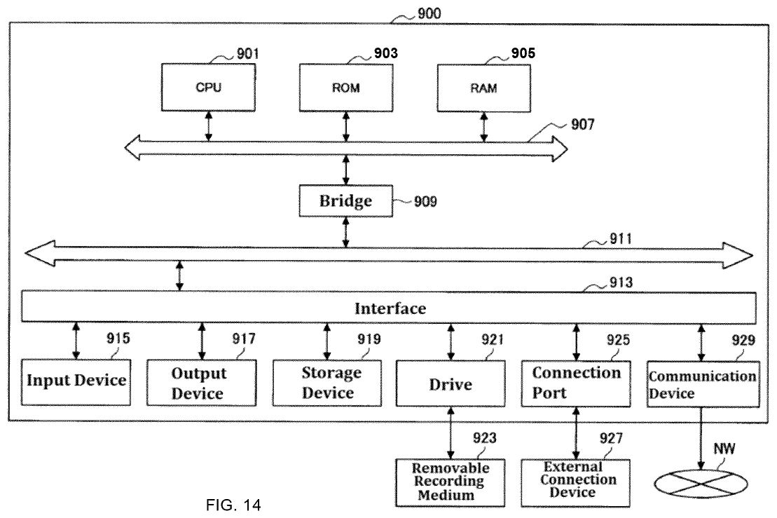

Referring to FIG. 14, the hardware configuration of the information processing device will be now described. FIG. 14 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### LIST OF REFERENCE NUMBERS

1 communication system
10 server
20 user terminal
30, 30a, 30b user terminal
LV distributor
AU1, AU2 viewer
VD, VD1, VD2 video image
NW network
30 user terminal
100 distribution unit
102 image capturing control unit
104 audio control unit
106 video transmission unit
108 distributor-side UI control unit
200 viewing unit
202 viewer-side UI control unit
204 superimposed information generation unit
206 input information transmission unit
302 distribution information providing unit
304 relay unit
306 gift processing unit
308 payment processing unit
310 stream DB
312 user DB
314 gift DB
330 classifying unit
332 recommending unit
334 detecting unit
350 interaction DB
352 distance DB
S1000, S1002, S1004, S1006, S1008, S1010, S1012 step S1014, S1016, S1018, S1020 step
900 information processing device
901 CPU
903 ROM
905 RAM
907 host bus
909 bridge
911 external bus
913 interface
915 input device
917 output device
919 storage device
921 drive
923 removable recording medium
925 connection port
927 external connection device
929 communication device

What is claimed is:

1. A method for recommendation, executed by a server, comprising:
obtaining viewer interaction data of a plurality of content types;
determining distance values between different content types according to the viewer interaction data;
determining a first viewer and a second viewer to have viewed a same content type;
determining a distance value between a first content type viewed by the first viewer and a second content type viewed by the second viewer according to the distance values; and
determining whether or not to recommend a stream corresponding to the first content type to the second viewer according to the distance value.

2. The method according to claim 1, further comprising:
determining the distance value to be greater than a distance threshold; and
recommending the stream to the second viewer.

3. The method according to claim 1, further comprising:
determining the distance value to be less than a distance threshold; and
determining not to recommend the stream to the second viewer.

4. The method according to claim 1, further comprising:
determining the first viewer and the second viewer to have interacted with the same content type;
determining the first viewer to have interacted with the first content type; and
determining the second viewer to have interacted with the second content type.

5. The method according to claim 1, further comprising:
determining a first distance value between two content types to be less when the viewer interaction data indicates that more viewers interacted with both the two content types; and
determining the first distance value between the two content types to be greater when the viewer interaction data indicates that fewer viewers interacted with both the two content types.

6. The method according to claim 1, wherein the viewer interaction data includes view durations, comment numbers, following actions, gifting numbers, gifting amount, or number of watched streams, from viewers.

7. The method according to claim 1, wherein the obtaining the viewer interaction data of the plurality of content types comprises:
detecting a timing of an interaction action from a viewer towards a content; and
detecting a content type of the content at the timing.

8. The method according to claim 1, further comprising:
obtaining all content types viewed by the second viewer within a predetermined time period;
determining a distance value between the first content type and each content type viewed by the second viewer within the predetermined time period according to the distance values:
determining the distance value between the first content type and each content type viewed by the second viewer within the predetermined time period to be equal to or greater than a distance threshold; and
determining to recommend the first content type to the second viewer.

9. A system for recommendation, comprising one or a plurality of processors, wherein the one or plurality of processors execute a machine-readable instruction to perform:
obtaining viewer interaction data of a plurality of content types;
determining distance values between different content types according to the viewer interaction data;
determining a first viewer and a second viewer to have viewed a same content type;
determining a distance value between a first content type viewed by the first viewer and a second content type viewed by the second viewer according to the distance values; and
determining whether or not to recommend a stream corresponding to the first content type to the second viewer according to the distance value.

10. A non-transitory computer-readable medium including a program for recommendation, wherein the program causes one or a plurality of computers to execute:
obtaining viewer interaction data of a plurality of content types;
determining distance values between different content types according to the viewer interaction data;
determining a first viewer and a second viewer to have viewed a same content type;
determining a distance value between a first content type viewed by the first viewer and a second content type viewed by the second viewer according to the distance values; and
determining whether or not to recommend a stream corresponding to the first content type to the second viewer according to the distance value.
